(19) United States
(12) Patent Application Publication
(10) Pub. No.: US 2026/0080522 A1
(43) Pub. Date: Mar. 19, 2026

(54) METHOD AND SYSTEM FOR OPTIMIZING AN IMAGE OF AN EYE

(71) Applicant: LUMENIS BE LTD., Yokneam (IL)

(72) Inventors: May Kleinman Ben Tsvi, Binyamina (IL); Adrian Graus, Kiriat Motzkin (IL)

(21) Appl. No.: 19/328,939

(22) Filed: Sep. 15, 2025

Related U.S. Application Data
(60) Provisional application No. 63/695,700, filed on Sep. 17, 2024.

(51) Int. Cl. G06T 5/94; G06T 5/40; G06T 7/00

(52) U.S. Cl. CPC G06T 5/94; G06T 5/40; G06T 7/0012; G06T 2207/30041

(57) ABSTRACT

A system and method for dynamically optimizing an eye image, comprising an imaging unit with a predetermined target intensity value, a memory, and at least one processor executing computer-readable code. The processor receives an eye image from the imaging unit and calculates an intensity profile along a region of interest (ROI). A maximum intensity point, representing the ROI center, and a maximum slope of the profile are identified. A symmetric profile is generated by mirroring the portion containing the maximum slope around the maximum intensity point. An optimized ROI is determined from the symmetric profile, and a grey level histogram is generated. A Cumulative Distribution Function (CDF) is calculated from the histogram. A predetermined percentage of pixels in the optimized ROI is set to be lower than an optimized target intensity value. Based on the CDF, the optimized target intensity value is calculated, and the imaging unit adjusts accordingly.

### BACKGROUND

The present invention is in the field of image processing and more specifically relates to a method and a system for optimizing an image of eye including features or elements of the eye. More particularly, images obtained employing a slit lamp and a camera. A slit lamp is a device used for diagnosing and/or treating an eye, and in some cases can be integrated with a laser system for treating the eye in the same optical path as that used for diagnosing the eye. The slit lamp typically emits a beam of light, used for examining the interior of the eye, with the option to change the beam width employing an integrated slit, and/or adjusting the beam's intensity. In the realm of image processing, optimizing image quality and fine-tuning image capture parameters is a fundamental challenge. Achieving the desired image quality in digital cameras involves a balance of exposure settings, sensor sensitivity, and image processing algorithms. These digital cameras typically use a predefined Regions of Interest (ROIs) outlined in configuration files. Notably, when these digital cameras are used with a slit lamp or ophthalmoscope device for examination of a human eye, the predefined ROIs may lead to a discrepancy with a slit groove width of the slit lamp device.

### SUMMARY

The presently disclosed subject matter provides methods and systems for optimizing image quality, specifically images of an eye that include features of the eye. The image quality optimization includes determining one or more of the following: an ROI in the image and the parameters of the camera capturing the image, including the exposure and brightness (intensity) level, (referred to as the “target”). In particular, the disclosed subject matter involves dynamic determination of the ROI and the target as a function of a selected slit width chosen by a user of a slit lamp (ophthalmoscope) device or as a function of the illumination intensity level also chosen by the user. The predetermined parameters of the capturing camera in such devices do not always result in the best image quality, and there is a need to redefine the parameters, including the target parameter, in various scenarios, to achieve a better quality and meaningful image. It will be appreciated that the invention can be implemented as an add-on feature to already installed slit lamp devices, e.g. as a firmware or software component running on the processing unit of the slit lamp device and/or the digital camera, that is connected thereto, and which processes the captured image for presenting on a dedicated display.

In accordance with a first aspect of the present invention, there is a system for dynamically optimizing an eye image, the system comprising: a memory and at least one processor connected to computer readable code in the memory, that upon execution of the computer readable code causes the processor to: receive an image of an eye; calculate an intensity profile of the image based on image pixels intensity along a region of interest (ROI) of the image; identify a maximum intensity point of the intensity profile, wherein the maximum intensity point is the center of the ROI; calculate a maximum slope of the intensity profile; generate a symmetric profile of the intensity profile by mirroring a portion of the intensity profile containing the maximal slope around the maximum intensity point; determine an optimized ROI based on the symmetric profile; generate a grey level histogram of the optimized ROI; calculate a Cumulative Distribution Function Graph (CDF) based on the grey level histogram; receive a predetermined percentage of the pixels in the optimized ROI to be lower than an optimized target intensity value for the image; calculate, based on the CDF, an optimized target intensity value in the optimized ROI, wherein the received predetermined percentage of the pixels exhibit intensity levels lower than an optimized target intensity value; determine the optimized target value; and display the optimized target value.

In another aspect, the system is configured to be used with at least one of: an imaging unit with a predetermined target intensity value configured to acquire the eye image; a slit lamp; or any combination thereof. The system further comprising an imaging unit with a predetermined target intensity value configured to acquire the eye images and send the eye images to the processor. The system wherein the processor instructs the imaging unit to adjust the predefined intensity value to the optimized target intensity value before acquiring more images and wherein the target intensity value is 80 out of an intensity scale of 255.

In one aspect, the system wherein the symmetrical profile limit of the ROI may be defined as 20 or 50 percent of the maximum intensity value of pixels and the system further comprises a saturation module configured to determine if the image is saturated and if the image is determined to be saturated the system does not continue. The system wherein the saturation module configured to determine image saturation when 25 percent of pixels in the image are above 200 intensity value. The system that further comprises a slit lamp device.

In yet another aspect, there is a method for dynamically optimizing an eye image, the method comprising: receiving, by a processor, an image of an eye; calculating, by the processor, an intensity profile of the image based on image pixels intensity along a region of interest (ROI) of the image; identifying, by the processor, a maximum intensity point of the intensity profile, wherein the maximum intensity point is the center of the ROI; calculating, by the processor, a maximum slope of the intensity profile; generating, by the processor, a symmetric profile of the intensity profile by mirroring a portion of the intensity profile containing the maximal slope around the maximum intensity point; determining, by the processor, an optimized ROI based on the symmetric profile; generating, by the processor, a grey level histogram of the optimized ROI; calculating, by the processor, a Cumulative Distribution Function Graph (CDF) based on the grey level histogram; receiving, by the processor, a predetermined percentage of the pixels in the optimized ROI to be lower than an optimized target intensity value for the image; calculating, by the processor, based on the CDF, an optimized target intensity value in the optimized ROI, wherein the received predetermined percentage of the pixels exhibit intensity levels lower than an optimized target intensity value; determining, by the processor, the optimized target value; and displaying, by the processor onto a display, the optimized target value.

In a final aspect, the method further comprises providing at least one of: an imaging unit with a predetermined target intensity value configured to acquire the eye image; a slit lamp device; or any combination thereof. The method further comprising providing an imaging unit with a predetermined target intensity value configured to acquire the eye images and send the eye images to the processor; and instructing, by the processor, the imaging unit to adjust the predefined intensity value to the optimized target intensity value before acquiring more images. The method wherein the target intensity value is 80 out of an intensity scale of 255. The method further comprising determining, by the processor, if the image is saturated and if the image is determined to be saturated the method does not continue; and wherein the saturation module configured to determine image saturation when 25 percent of pixels in the image are above 200 intensity value.

### BRIEF DESCRIPTION OF THE DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a schematic view of a system for optimizing eye images, in accordance with non-limiting embodiments of the present invention.

FIG. 2 illustrates a flowchart of a method for optimizing eye images, in accordance with non-limiting embodiments of the present invention.

FIG. 3 illustrates an image of an ROI based on predefined slit width, before applying the technique of the present invention.

FIG. 4 illustrates a profile of cumulative brightness (intensity) of pixels in each column of the predefined ROI of an eye image, in accordance with non-limiting embodiments of the present invention.

FIG. 5 illustrates a method to generate a symmetrical brightness (intensity) profile based on identification of the slit edge in the image, in accordance with non-limiting embodiments of the present invention.

FIG. 6 illustrates a histogram employed in the method of the present invention, in accordance with non-limiting embodiments of the present invention.

FIG. 7 illustrates a percentage of pixels corresponding to the particular intensity value as a cumulative distribution function related to the histogram of FIG. 6, in accordance with non-limiting embodiments of the present invention.

FIGS. 8-15 illustrate examples of images before and after optimization, in accordance with non-limiting embodiments of the present invention.

The figures depict embodiments of the inventions for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description that follows may be better understood. It should be appreciated by those skilled in the art that the conception and specific embodiments disclosed may be readily utilized as a basis for modifying or designing other structures for carrying out the same purposes of the present invention. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In general, images of an eye are commonly employed in the field of ophthalmology, medical diagnostics, and treatments such as laser treatments. They provide a non-invasive way to visualize the complex structures within the eye and may offer an in-depth view of the eye, including the ocular surface, iris, pupil, lens, retina, blood vessels, optic nerve, and other critical structures. These images are routinely used for early detection and ongoing monitoring of various ocular conditions, such as diabetic retinopathy, glaucoma, and age-related macular degeneration. They also serve to assess overall eye health, helping to diagnose eye diseases and guide treatment decisions. Eye images may serve as an essential part of routine eye examinations, as well as in the diagnosis and monitoring of various ocular diseases, including, but not limited to, angle closure in glaucoma, microaneurysms diabetic retinopathy, and drusen deposits in macular degeneration. Through the examination of eye images, healthcare professionals and ophthalmologists can detect and identify irregularities/abnormalities, track disease progression, and create tailored treatment plans to preserve vision and address eye-related disorders. In some embodiments, the images are employed to document/guide laser treatments and for educational purposes.

In some embodiments, and as will be further illustrated below, there is a method of dynamic determination of an optimized ROI and an optimized target intensity value/level for an imaging unit. This determination may be as a function of a selected slit width chosen by a user and/or medical professional. For the purposes of this disclosure, an open slit groove size of a slit lamp is a field of view illumination of the eye and typically but not always the maximum in width a slit lamp is capable of emitting a beam of light. For the purposes of this disclosure, a narrow-slit groove size of a slit lamp is any width narrower than the field of view. Various embodiments of the present disclosure provide a technical solution by using a dynamic image optimization system that may include an imaging unit with a slit lamp device to achieve a better quality and a meaningful image. This improved image or plurality of images assists in determining an improved eye diagnosis and treatments.

In some exemplary embodiments of the present invention, the image optimization system is configured to optimize the quality of eye images by determining a target brightness (intensity) value for pixels within an ROI. This target intensity value is determined so that a predefined percentage of the pixels in the ROI or in the optimized ROI may exhibit intensity levels lower than the determined target intensity value, and therefore the remaining pixel percentage is above the intensity target value. This feature may enable the system to set specific intensity thresholds for analyzing the eye image(s) effectively. Intensity value for images is typically a pixel value from 0 (zero) intensity representing black to 255 (two hundred and fifty-five) intensity representing white as well as the maximum intensity value. The intensity value is usually per pixel in an image.

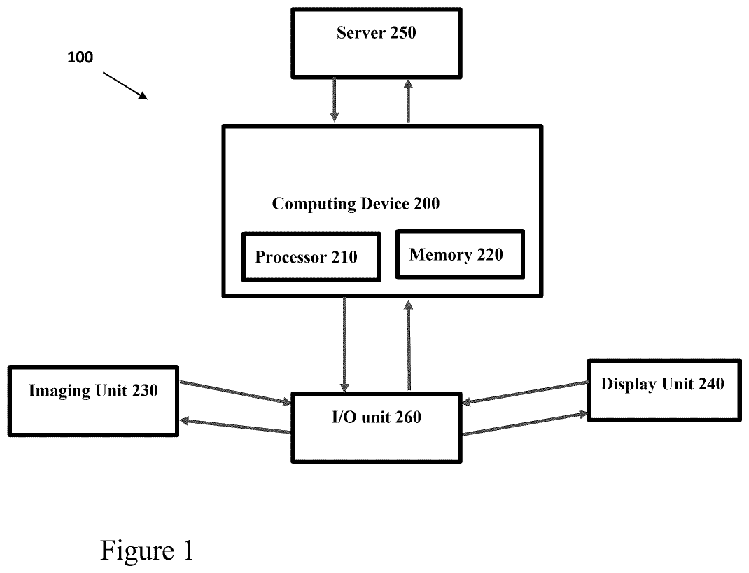

FIG. 1 depicts a schematic view of a non-limiting example of an image optimization system (100) for optimizing images of an eye, enhancing eye visual presentation of features or elements of the eye. In one exemplary embodiment, the system comprises a computing device (200) including a memory (220) and a processor (210) connected to the memory (220). The processor (210) is configured to execute the steps of a nonlimiting exemplary method described below. The processor (210) may also retrieve and execute programming instructions stored on a storage medium as part of the system. The image optimization system may further comprise an imaging unit (230) which may be a camera mounted on a slit lamp system, configured to acquire at least one eye image. In some embodiments of the present invention, the image optimization system (100) with the computing device (200) and the processor (210) is configured to facilitate a seamless and coordinated operation. The computing (200) device may work with the processor (210) and may serve as a central command center for managing and directing the various tasks and functions involved in the eye image optimization process.

It will be appreciated that the image optimization system can be implemented as an add-on feature to a slit lamp device, e.g. as a firmware or software component running on the processing unit of the slit lamp device and/or a digital camera, that is connected thereto, and which processes the captured images for presenting on a dedicated display. The image optimization system may alternatively be integrated within a slit lamp device and/or the digital camera. In some embodiments, when capturing images using a digital camera attached to the slit lamp device (where the camera is integrated to view the same optical path as the slit lamp binocular in order to “see” the same image), the user can change the slit width or the illumination intensity during the treatment, thus affecting the image quality of the captured images.

In some of the exemplary embodiments of the present invention, the computing device (200) may be coupled with an input/output (I/O) unit (260). An I/O unit may encompass various devices and interfaces designed to interact with the image optimization system. The devices connected to the I/O unit may be, but not limited to, a display, an imaging unit, a computer keyboard, and a mouse. In the context of receiving eye images, the I/O unit serves as the interface through which images are obtained from an imaging unit (230) and integrated into the system. The I/O unit can take various forms to accommodate different scenarios and sources of eye imagery. Specialized scanning equipment may be considered as part of the I/O unit. These devices can capture cross-sectional images of an eye and transfer them to the computing device.

In some embodiments, imaging unit (230) is specifically designed for the capture of eye images. Alternatively, imaging unit (230) may provide a component for acquiring high-quality images of the eye. In some exemplary embodiments of the present invention, a digital camera may be utilized as the imaging unit (230). When imaging unit (230) is a digital camera, the digital camera may be configured for eye image capture and may act as a component within the image optimization system (100). A digital camera's advanced features and capabilities may play an essential role in achieving high-quality eye images for diagnostic, treatment, and other clinical purposes. The digital camera's attributes may include a high-resolution sensor, specialized optics, and controlled lighting, allowing for precise and detailed imaging of the eye. Its sensor technology may capture intricate eye structures with clarity, while the optical system, comprising lenses and apertures, may effectively manage light and focus, ensuring that the eye images are accurate and sharp. The imaging unit may acquire an eye image or a plurality of eye images from a slit lamp device. In some embodiments, a plurality of eye images are taken continuously as a video live image.

In addition, the I/O unit may also encompass a display unit (240) for displaying images. In some embodiments, the display unit (240) is a high-resolution computer monitor specifically designed for ophthalmic applications. This type of display ensures that the eye images and their optimized parameters are presented with clarity and detail. The eye image(s) may be captured locally and then shared with medical professional specialists who can view and assess the results in real time on an additional display unit(s).

Typically, slit grooves of a slit lamp device are designed to enable a user to concentrate on a clinical ROI. The presence of slit grooves usually enables controlled and precise adjustments in width of the ROI and image capture parameters, contributing to enhanced image quality. The design of the slit grooves influences the illuminated ROI. The ROI correlates to the illuminated portion within the eye image. The slit grooves presence in the acquired image assists in the identification and delineation of the ROI, and for optimizing the capturing parameter of the imaging unit (230).

In some exemplary embodiments of the present invention, the computing device (200) may be connected to a server (250). This connection to a server can facilitate various data processing and management tasks, making it possible to efficiently handle and distribute information within a network or system.

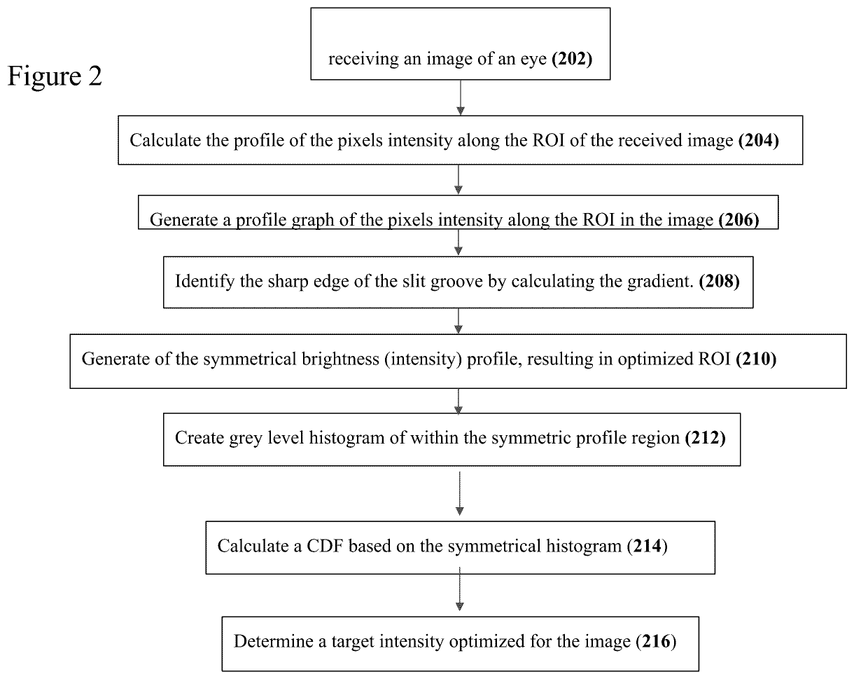

FIG. 2 is a flow chart illustrative of a non-limiting example of the process in some embodiments of the current disclosure.

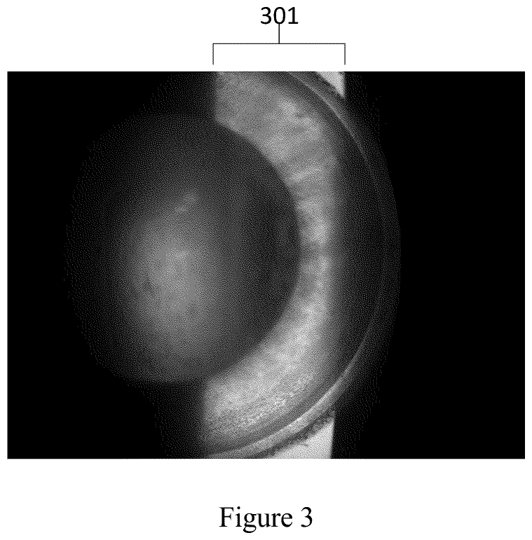

At (202), in some embodiments, the image optimization system receives an image or a plurality of images of an eye from an imaging unit (230). FIG. 3 is an illustrative image received by the image optimization system. These images may be captured using specialized ophthalmic equipment, for example, an imaging unit that may include a slit lamp device. The image received may have a predetermined ROI set by the imaging unit. The image received may have a predefined intensity value based on the preset parameters of the imaging unit. For instance, a typical imaging unit used for capturing images of a human eye uses a target intensity value of 80 (out of intensity scale of 255). In some embodiments, the image optimization system determines a new parameter value for the imaging unit, such as, but not limited to adjusting auto exposure/gain. In some embodiments, the new parameter is configured to ensure that a predetermined percentage of image pixels within the ROI are below the level of 80, while the remaining percentage should be above this threshold. The predetermined percentage of image pixels may be 0.7 or 70%. This predetermined percentage may be any percentage. Typically, in image processing, 70 % of image pixels below the intensity level is considered standard practice in the image capture field for generating good quality images.

At (204), in some embodiments, the image optimization system dynamically determines the precise position and width of a slit groove within the effective ROI (see 301 in FIG. 3) In some embodiments, the exact location and dimensions (e.g., width) of the slit groove is determined. The ROI may include areas of potential clinical significance, aiding in the detection of abnormalities like microaneurysms in diabetic retinopathy or drusen deposits in macular degeneration, or angle closure in glaucoma.

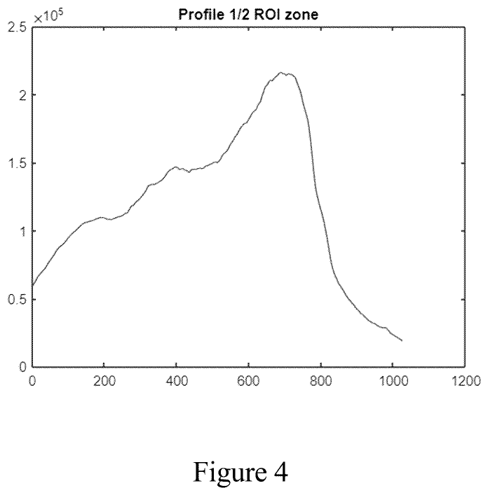

At (206), in some embodiments, the image optimization system dynamically generates a profile graph of pixel intensity. FIG. 4 is a non-limiting example of a profile which is a graphical representation of the cumulative intensity of pixels in each column and the distribution of pixel intensity values within an image. The X axis of FIG. 4 represents columns of pixels along an X axis of the received image's predetermined ROI. The ROI correlates to the illuminated portion within the eye image. Each of the column of pixels has a number value in the X axis of FIG. 4. The Y axis of FIG. 4 is the intensity level of the pixel columns. FIG. 4 is asymmetric, i.e., the maximum slope on the right side of the profile represents a sharp edge of the slit groove. That is, the intensity asymmetry around the slit width is reflected in the profile.

At (208), in some embodiments, the image optimization system dynamically calculates the gradient of FIG. 4 to identify a visual sharp edge of the slit groove. A maximum slope may then be calculated. By way of specific example, the profile, as shown in FIG. 4 shows a relative sharp decrease in the intensity value at the right side at columns 700-1000. In contrast, a slower decrease is shown at the left (column 0-700). By way of specific example, the maximum sum of the intensity value in FIG. 4 is located about column 700. The maximum intensity value in the intensity profile represents the center of the slit groove.

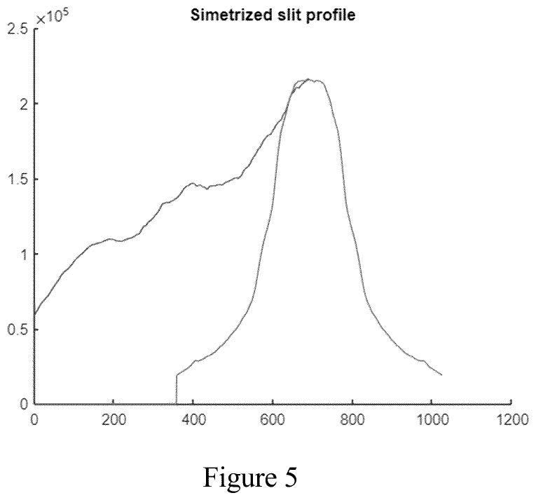

At (210), in some embodiments, the image optimization system dynamically determines and generates a symmetrical intensity profile based on slit width natural symmetry of the slit groove. In some embodiments, building a symmetric profile of the intensity profile is done by identifying a maximum intensity point or value of the intensity profile from the asymmetric profile, and then mirroring a portion of the profile containing a maximal slope around the maximum intensity point, which is considered as the center of the region of interest. FIG. 5 represents a non-limiting symmetrical profile determined by mirroring the sharp decrease in intensity value from the right side of the maximum intensity value to the left side of the maximum intensity value. This symmetrical profile may represent an optimized ROI.

In some embodiments, the image optimization system may be configured to identify optimized ROIs based on predetermined criteria such as the presence of anatomical structures, or pathological features. The ROI may include areas of potential clinical significance. In one non-limiting example, determining the left and right limits of the symmetric profile (profile width) is based on a predetermined percentage of the maximum profile signal. Utilizing a predetermined percentage of the maximum profile signal, the method may identify boundaries for modification. In some embodiments, the symmetrical profile limit of the ROI may be defined as 20 percent of the maximum intensity value of the pixels. In another non-limiting example, the symmetrical profile limit of the ROI may be defined as 50 percent of the maximum intensity value of the pixels. The edge provided to the slope defines the width of the slit groove, which in this non-limiting example is 413 pixels (or pixel columns).

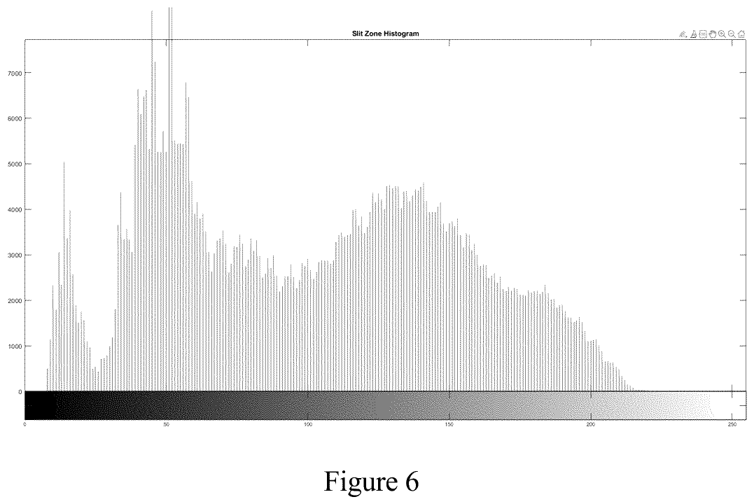

At (212), in some embodiments, the image optimization system dynamically generates a grey level histogram for the determined optimized ROI at (210). FIG. 6 illustrates the histogram with the number of pixels on the Y-axis corresponding to a particular intensity value in a grayscale level on the X-axis representing the intensity level or value in the optimized ROI. Essentially, the histogram may serve as a visual summary that may show how frequently each pixel intensity may occur throughout the image. In a typical grayscale image, the histogram may potentially display the range of pixel values from black (intensity 0) to white (maximum intensity, often 255), along with various shades of gray in between.

In some embodiments, the histogram may aid in detecting areas of image saturation, where pixel values may exceed the sensor's dynamic range. By analyzing the histogram, one may determine whether an image may be underexposed, overexposed, or properly exposed. This assessment is essential for potentially capturing high-quality images with accurate brightness and contrast.

In some exemplary embodiments of the present invention, the method may include the assessment of whether the percentage of saturated pixels may surpass a predetermined threshold within the effective Region of Interest (ROI) and therefore indicate saturation. In some embodiments, saturation of an image is determined when about 25% of the pixels are above 200 intensity value. When saturation occurs, it may suggest that certain portions of the image have become overly bright or vivid, potentially resulting in a loss of visual information and image quality. In some embodiments, when saturation of the image is determined, the camera parameters are reconfigured to a target intensity value of 100 without calculating the new target intensity value from the CDF. Therefore, no further steps of the process are calculated.

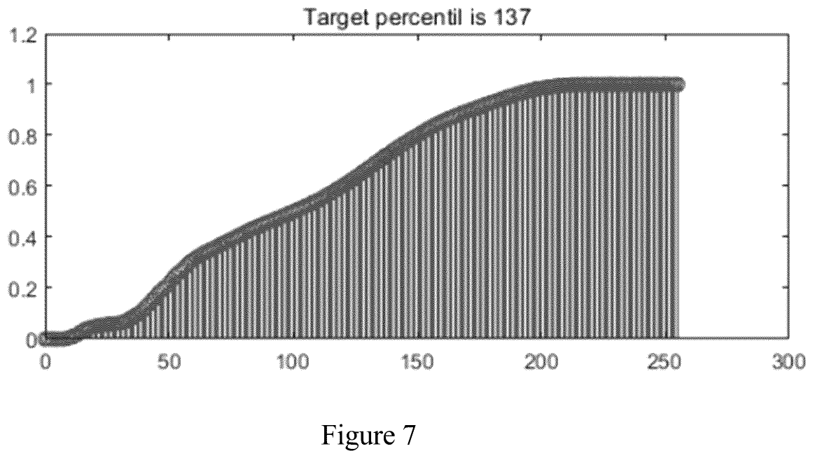

At (214), in some embodiments, the image optimization system dynamically calculates a Cumulative Distribution Function/Graph (CDF) based on the symmetrical histogram. FIG. 7 illustrates a CDF of the percentage of pixels corresponding to a particular intensity value, normalized to 1, based on the histogram in FIG. 6. In the context of digital image analysis and data distribution, a CDF is a mathematical concept that may be used to describe how data values are distributed within a dataset. It provides a cumulative view of the probability distribution, indicating the probability that a data point will fall below or equal to a specific value. In practical terms, a CDF may show how data accumulates as values increase or decrease. When applied to image processing, a CDF can be used to analyze the distribution of pixel intensities within an image.

By way of non-limiting example, after applying the target criteria (in this case 70% which is 0.7) we can find the correlating target intensity optimized for this image, here 137. The 70% of the pixels may have intensity value lower than 137 and 30% of the pixels may have intensity value higher than 137 for achieving the optimized image. This percentile value may be instrumental in determining image exposure settings, contributing to the optimization of image capture parameters and potential enhancements in image quality. Therefore, the target intensity value which was initially defined as 80 may be modified to 137. In some exemplary embodiments of the present invention, the target percentage may be user adjustable.

At (216), in some embodiments, the image optimization system dynamically determines target intensity optimized for the received image. The imaging unit parameters for intensity level (camera exposure) may be adjusted to the determined target intensity level. In some exemplary embodiments of the present invention, the method may include adjusting auto exposure parameters based on the determined target intensity value. These parameters, including percentile, target, and tolerance, fine-tune the camera's response to varying lighting conditions. The “percentile” parameter represents the desired distribution of pixel intensities within the region of interest, indicating the balance between darker and brighter areas. The “target” parameter signifies the specific intensity level to be used for auto exposure calculations, contributing to the image's overall brightness and contrast. Lastly, the “tolerance” parameter defines the algorithm's convergence cycles, ensuring that the optimization process efficiently adjusts the exposure settings to achieve the desired outcome. In some embodiments, the imaging unit (230) continuously captures images of the eye, and the image optimization system optimizes the images in real time. In some embodiments, this enables the user to change the slit illumination or width in real time to produce optimized images.

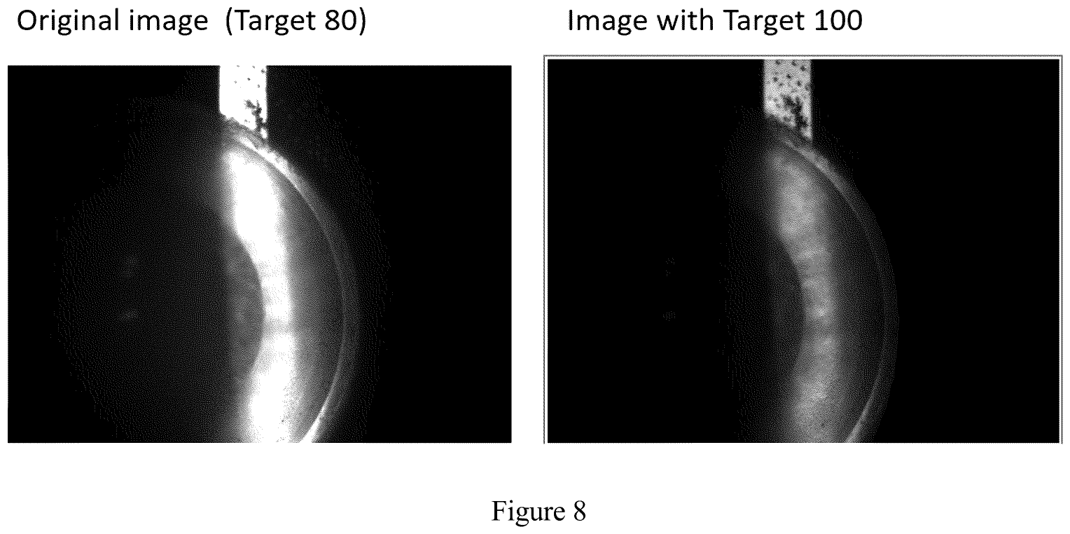

By way of non-limiting specific example, FIG. 8-15 illustrate images received by the imaging optimization system and new parameters determined for image acquisition and new images acquired employing the new parameters.

FIG. 8 is an image received with a predefined intensity value of 80 and a magnification level set at ×16 obtained from a narrow-slit groove size. The image optimization system determined this image is saturated. A new image is acquired with the intensity value of 100 and is shown on the right. Intensity value 100, is employed to correct image saturation based on extensive experimentation.

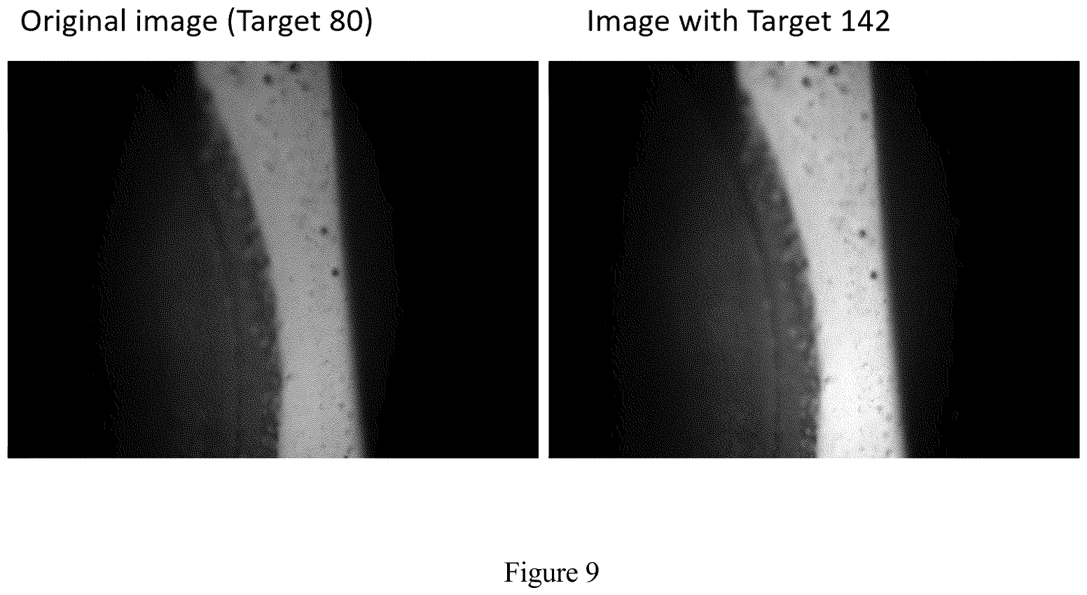

FIG. 9 is an image received with a predefined intensity value of 80 and a magnification level set at ×42 obtained from a narrow-slit groove size. The image optimization system determines a new target intensity value of 142 and a new image is acquired with the intensity value of 142 is shown on the right.

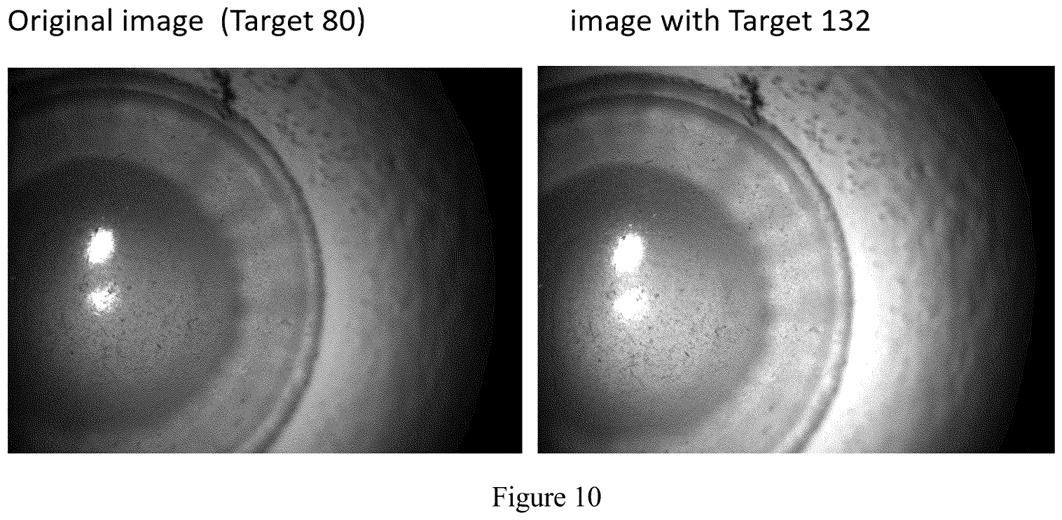

FIG. 10 is an image received with a predefined intensity value of 80 and a magnification level set at ×16 obtained from an open slit groove size. The image optimization system determined a new target intensity value of 132 and a new image is acquired with the intensity value of 132 as shown on the right.

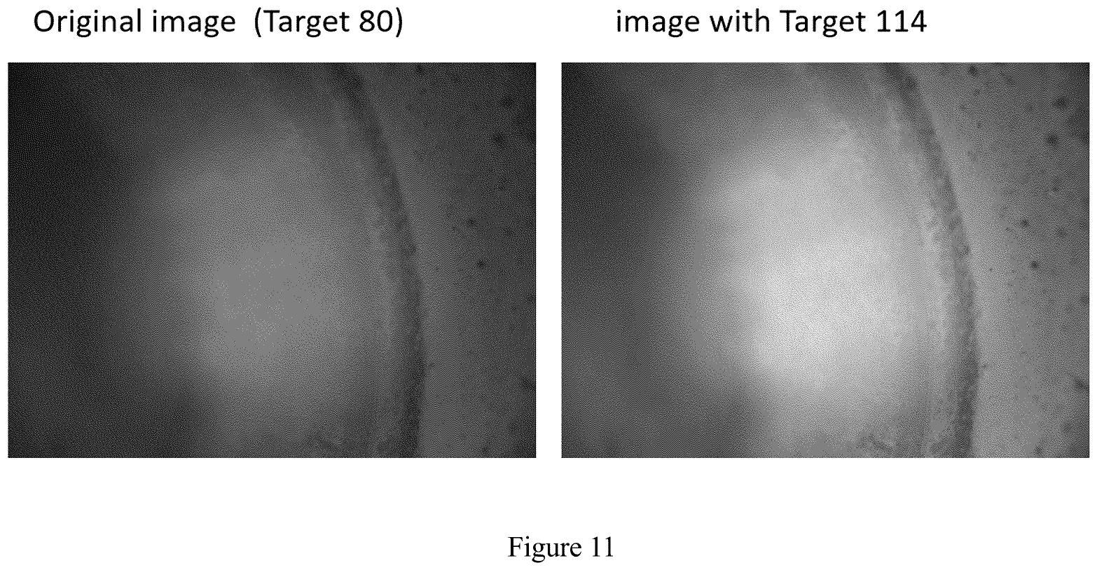

FIG. 11 is an image received with a predefined intensity value of 80 and a magnification level set at ×42 obtained from a full open slit groove size. The image optimization system determined a new target intensity value of 114 and a new image is acquired with the intensity value of 114 as shown on the right.

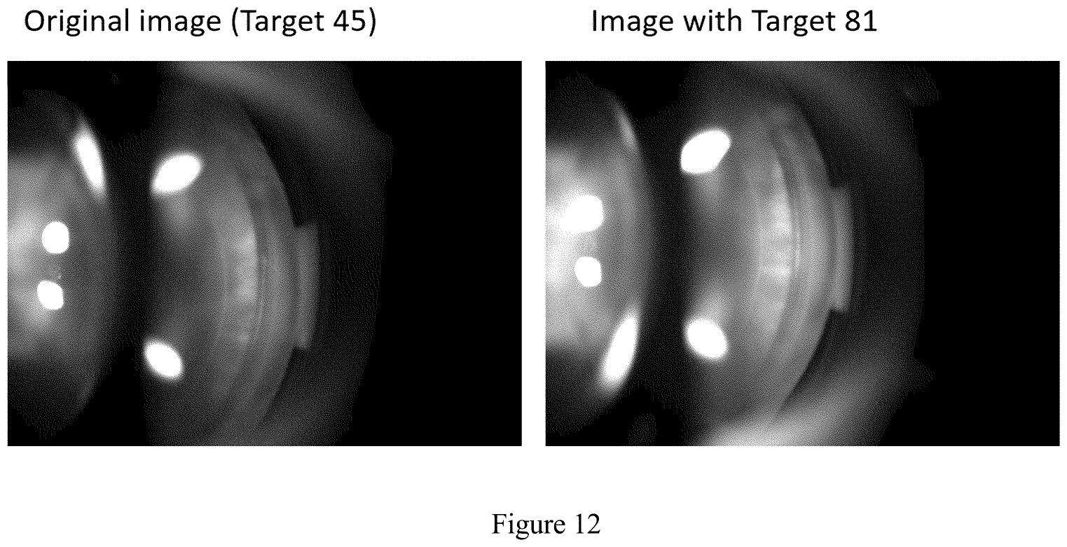

FIG. 12 is an image received with a predefined intensity value of 45 and a magnification level set at ×16 obtained from a narrow-slit groove size. In addition, a Latina lens, commonly used for Selective Laser Trabeculoplasty (SLT) treatment was used. The image optimization system determined a new target intensity value of 81 and a new image is acquired with the intensity value of 81 as shown on the right.

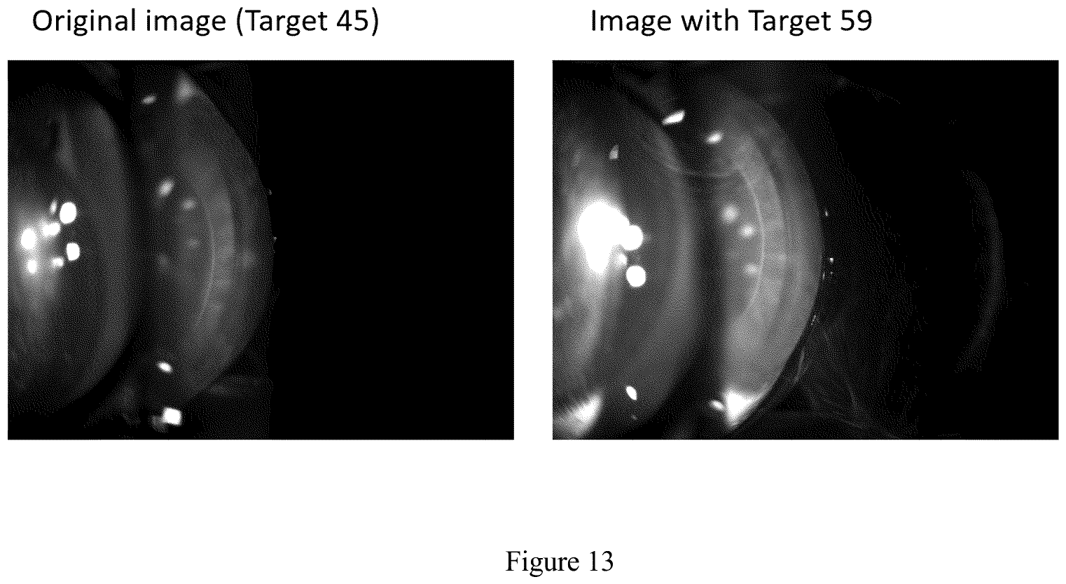

FIG. 13 is an image received with a predefined intensity value of 45 and a magnification level set at ×16 obtained from a narrow-slit groove size. In addition, a Gonioscopy lens with 4 mirrors was used. The image optimization system determined a new target intensity value of 59 and a new image is acquired with the intensity value of 59 as shown on the right.

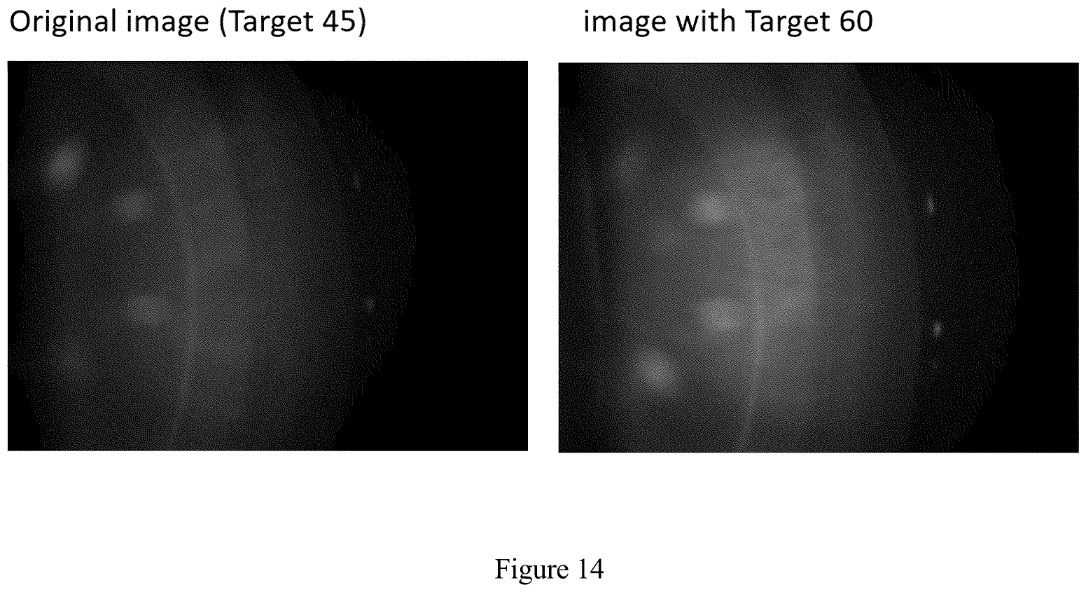

FIG. 14 is an image received with a predefined intensity value of 45 and a magnification level set at ×42 obtained from a narrow-slit groove size. In addition, a Gonioscopy lens was used. The image optimization system determined a new target intensity value of 60 and a new image is acquired with the intensity value of 60 as shown on the right.

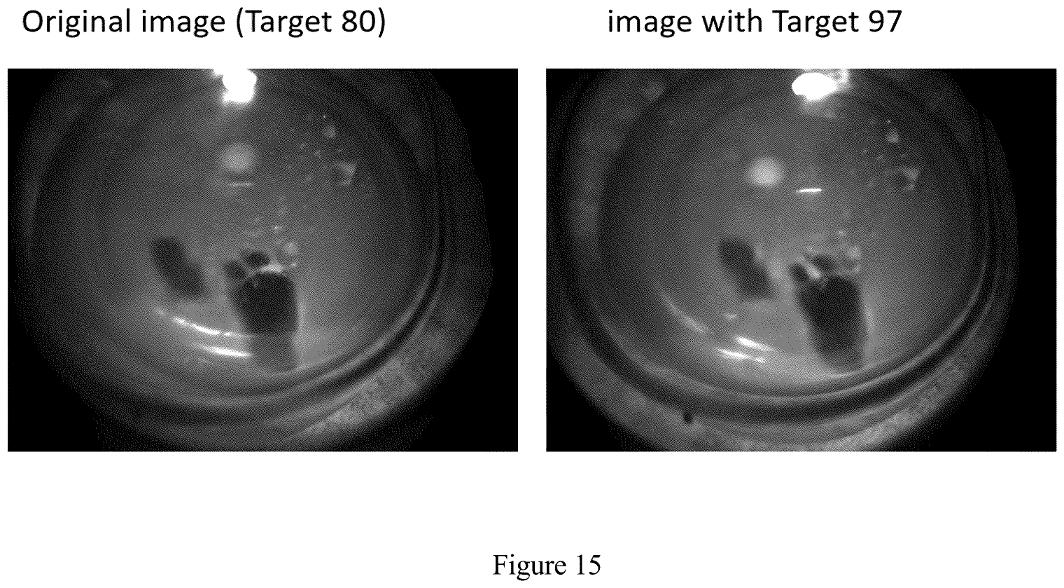

FIG. 15 is an image received with a predefined intensity value of 80 and a magnification level set at ×16 obtained from an open slit groove size. In addition, a specialized capsulotomy lens was employed. The image optimization system determined a new target intensity value of 97 and a new image is acquired with the intensity value of 97 as shown on the right.

It is understood that at least one aspect/functionality of various embodiments described herein can be performed in real-time and/or dynamically. As used herein, the term “real-time” or “near real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process. In some embodiments, events and/or actions in accordance with the present disclosure can be in real-time, near real-time, and/or based on a predetermined periodicity of at least one of: nanosecond, several nanoseconds, millisecond, several milliseconds, second, several seconds, minute, several minutes, hourly, several hours, daily, several days, weekly, monthly, etc. As used herein, the term “dynamically” and term “automatically,” and their logical and/or linguistic relatives and/or derivatives, mean that certain events and/or actions can be triggered and/or occur without any human intervention.

In some embodiments, the material disclosed herein may be implemented in hardware and software or firmware or a combination of them or as instructions stored on a non-transitory machine-readable medium, which may be read and executed by one or more processors. The image optimization system (100) may be hosted on a single computing device or server. Alternatively, the features and functions of the image optimization system (100), as described herein, may be distributed over a plurality of networked computers, which may consist of or include computers serving a cloud platform. In this disclosure, processor (210) and/or computing device (200) (in the singular) is understood to mean one or more processors (210) and/or one or more computing devices (210). The image optimization system may be hosted on a single computing device, or the features and functions may be distributed over a plurality of networked computing devices. Further, the processor (210) may be in wired or wireless connection to one or more non-transitory computer-readable media that may comprise any combination of volatile memory, non-volatile memory, and storage devices.

1. A system for dynamically optimizing an eye image, the system comprising:
a memory and at least one processor connected to computer readable code in the memory, that upon execution of the computer readable code causes the processor to:
receive an image of an eye;
calculate an intensity profile of the image based on image pixels intensity along a region of interest (ROI) of the image;
identify a maximum intensity point of the intensity profile, wherein the maximum intensity point is the center of the ROI;
calculate a maximum slope of the intensity profile;
generate a symmetric profile of the intensity profile by mirroring a portion of the intensity profile containing the maximal slope around the maximum intensity point;
determine an optimized ROI based on the symmetric profile;
generate a grey level histogram of the optimized ROI;
calculate a Cumulative Distribution Function Graph (CDF) based on the grey level histogram;
receive a predetermined percentage of the pixels in the optimized ROI to be lower than an optimized target intensity value for the image;
calculate, based on the CDF, an optimized target intensity value in the optimized ROI, wherein the received predetermined percentage of the pixels exhibit intensity levels lower than an optimized target intensity value;
determine the optimized target value; and
display the optimized target value.

2. The system according to claim 1, configured to be used with at least one of:
an imaging unit with a predetermined target intensity value configured to acquire the eye image;
a slit lamp device; or
any combination thereof.

3. The system according to claim 1, the system further comprising an imaging unit with a predetermined target intensity value configured to acquire the eye images and send the eye images to the processor.

4. The system according to claim 2, wherein the processor instructs the imaging unit to adjust the predefined intensity value to the optimized target intensity value before acquiring more images.

5. The system according to claim 3, wherein the processor instructs the imaging unit to adjust the predefined intensity value to the optimized target intensity value before acquiring more images.

6. The system according to claim 1, wherein the target intensity value is 80 out of an intensity scale of 255.

7. The system according to claim 1, wherein the symmetrical profile limit of the ROI may be defined as 20 or 50 percent of the maximum intensity value of pixels.

8. The system according to claim 1, the system further comprises a saturation module configured to determine if the image is saturated.

9. The system according to claim 8, wherein the saturation module configured to determine image saturation when 25 percent of pixels in the image are above 200 intensity value.

10. The system according to claim 1, wherein the system further comprises a slit lamp device.

11. A method for dynamically optimizing an eye image, the method comprising:
receiving, by a processor, an image of an eye;
calculating, by the processor, an intensity profile of the image based on image pixels intensity along a region of interest (ROI) of the image;
identifying, by the processor, a maximum intensity point of the intensity profile, wherein the maximum intensity point is the center of the ROI;
calculating, by the processor, a maximum slope of the intensity profile;
generating, by the processor, a symmetric profile of the intensity profile by mirroring a portion of the intensity profile containing the maximal slope around the maximum intensity point;
determining, by the processor, an optimized ROI based on the symmetric profile;
generating, by the processor, a grey level histogram of the optimized ROI;
calculating, by the processor, a Cumulative Distribution Function Graph (CDF) based on the grey level histogram;
receiving, by the processor, a predetermined percentage of the pixels in the optimized ROI to be lower than an optimized target intensity value for the image;
calculating, by the processor, based on the CDF, an optimized target intensity value in the optimized ROI, wherein the received predetermined percentage of the pixels exhibit intensity levels lower than an optimized target intensity value;
determining, by the processor, the optimized target value; and
displaying, by the processor onto a display, the optimized target value.

12. The method according to claim 11, further comprising providing at least one of:
an imaging unit with a predetermined target intensity value configured to acquire the eye image;
a slit lamp device; or
any combination thereof.

13. The method according to claim 11, the method further comprising:
providing an imaging unit with a predetermined target intensity value configured to acquire the eye images and send the eye images to the processor.

14. The method according to claim 12, further comprising:
instructing, by the processor, the imaging unit to adjust the predefined intensity value to the optimized target intensity value before acquiring more images.

15. The method according to claim 13, further comprising:
instructing, by the processor, the imaging unit to adjust the predefined intensity value to the optimized target intensity value before acquiring more images.

16. The method according to claim 11, wherein the target intensity value is 80 out of an intensity scale of 255.

17. The method according to claim 11, further comprising:
determining, by the processor, if the image is saturated and, if the image is determined to be saturated, discontinuing the method.

18. The method according to claim 17, wherein the saturation module configured to determine image saturation when 25 percent of pixels in the image are above 200 intensity value.
